(19) United States
(12) Patent Application Publication
(10) Pub. No.: US 2025/0245272 A1
(43) Pub. Date: Jul. 31, 2025

(54) DYNAMICALLY REFERENCED DOCUMENT GENERATION

(71) Applicant: Brencol Pty Ltd, Turramurra, New South Wales (AU)

(72) Inventor: James Richard Clouten, Turramurra, New South Wales (AU)

(21) Appl. No.: 18/705,258

(22) PCT Filed: Oct. 28, 2022
(86) PCT No.: PCT/AU2022/051303

§ 371 Date: Apr. 26, 2024

(30) Foreign Application Priority Data
Oct. 29, 2021 (AU) 2021903469

(51) Int. Cl. G06F 16/93

(52) U.S. Cl. CPC G06F 16/93

(57) ABSTRACT

Disclosed is a computer-implemented document preparation method, for preparation of a document object comprising a primary document portion and one or more supporting attachments referenced in the primary document portion. The method comprises: providing a primary document interface in which a primary document can be composed or edited by a user. This provides a work area for the creation of the primary document portion. The method provides a reference insertion function and a reference removal function which are user accessible. The one or more referenced supporting attachments are provided as collation, in which the referenced supporting documents are arranged in order of their referencing in the primary document portion as auto generated by the software. The method comprises compiling the collation with the primary document portion to generate a finalised document.

### TECHNICAL FIELD

This disclosure relates to a method and system for document generation, particular generation of documents with dynamically updatable referencing. In particular embodiments, references assigned to secondary files linked to an electronic document is dynamically associated with a work flow in creating the electronic document.

### BACKGROUND ART

In preparing an electronic report document, the author creating the document sometimes has to use a certain type of formatting, or a document template type. Some of these report formatting requirements are to meet Statutory compliance, or they can be to meet business internal or external procedures and policies formats (i.e. daily, weekly, monthly, annual reports etc . . . ).

Currently, it is in many cases possible for an author to import an existing template, for instance from the internet, an online library, or a previously prepared report, to set the correct formatting structure for these reports or documents.

However, sometimes the formatting of the imported template will not be replicated in the destination computer to have the same appearance, as the presentation of the template will be subject to the software being utilized.

Further, supporting documentation may need to be referenced in some electronic documents. Some example of documents potentially requiring support documentations may include declarations which mention particular evidence. Typically this refers to a document at a particular location. The document may potentially be altered after a reference to it is made in the primary document. Or, the referenced document attachment may be stored at a location which is not available to everyone who needs to read or edit the document.

It is to be understood that, if any prior art is referred to herein, such reference does not constitute an admission that the prior art forms a part of the common general knowledge in the art, in Australia or any other country.

### SUMMARY

In one aspect, disclosed is computer-implemented document preparation method, for preparation of a document comprising a primary document, the primary document referencing one or more supporting attachments. The method comprises: providing a primary document interface in which a primary document can be composed or edited by a user; assigning to each instance of a reference to a supporting attachment a unique attachment marker, the attachment marker comprising an attachment marker name and an automatically determined attachment marker index key, wherein the automatically determined attachment marker index key is updatable in accordance with any changes to references made in the primary document, to reflect a current order in which the references are made. A finalised document in which one or more attachment markers are embedded is then compiled.

In one aspect, disclosed is a computer-implemented document preparation method, for preparation of a document object comprising a primary document portion and one or more supporting attachments referenced in the primary document portion. The method comprises: providing a primary document interface in which a primary document can be composed or edited by a user. This provides a work area for the creation of the primary document portion. The method provides a reference insertion function and a reference removal function which are user accessible. The one or more referenced supporting attachments are provided as collation, in which the referenced supporting documents are arranged in order of their referencing in the primary document portion as auto generated by the software. The method comprises compiling the collation with the primary document portion to generate a finalised document.

In some forms of the above methods, the one or more referenced supporting attachments may be provided as collation, in which the referenced supporting documents are arranged in order of their referencing in the primary document portion. Thus the method may comprise compiling the collation with the primary document portion to generate a finalised document.

In some forms, the method comprises providing a reference insertion function and a reference removal function which are user accessible.

In some forms, a user-triggered invocation of the reference insertion function causes a reference selection interface portion to be displayed. The reference selection interface portion may comprise a first interface element for selection of a supporting attachment to be referenced, from a listing of one or more supporting attachments included in a local library. The reference selection interface portion may further comprise a second interface element, being a new reference selection interface element, for selection of a supporting item of information not included in the local library.

In some forms, the reference insertion function may be configured for: upon user confirmation of a selection from said listing of supporting attachments, checking whether the selected supporting attachment has been previously referenced in the primary document portion. In the positive, designating the selected supporting attachment as the supporting attachment to be referenced by the invocation of the reference insertion function. In the negative, designating the selected supporting attachment as the supporting attachment to be referenced by the invocation of the referenced insertion function, and designating the selected supporting attachment for inclusion with the primary document portion.

In some forms, the method comprises the steps of, upon user activation of the new reference selection interface element, triggering a display of a file selection window for navigation through a data storage system separate from the local library; enabling a selection of a file stored in the data storage system as a supporting item of information; making a duplicate copy of the selected supporting item of information; saving the copy as a new supporting attachment and including the new supporting attachment in the local library; and designating the new supporting attachment as the supporting attachment to be referenced by the invocation of the reference insertion function, and designating the new supporting attachment for finalisation with the primary document.

Once the referenced supporting attachment is set, a compiled document may be prepared. In some forms, compilation of the collation includes collating the supporting attachments designated for finalisation with the primary document, in an order in which the supporting attachments are referenced and associating the collated supporting attachments with the primary document.

In some forms, the method comprises, upon user-triggered invocation of the reference insertion function to add reference to a supporting attachment: displaying an attachment marker selection interface configured to prompt a user input of an attachment marker name. The attachment marker name may be an already used or a new attachment marker name.

In some forms, the method may include generating the attachment marker to be assigned to the referenced supporting attachment, and inserting the attachment marker into the primary document. The attachment marker may comprise the attachment marker name at least in part and an automatically assigned attachment marker index key. The attachment marker index key may be one of a set of sequentially arranged index values. The attachment marker index key may be assigned based on the attachment marker name.

In some forms, the automatic assigning of the attachment marker index key comprises: if the attachment marker name is a new attachment marker name, assigning a first index value of the set of sequentially arranged indices as the attachment index key; or if the attachment marker name is a used attachment marker name, identifying a last used attachment marker in the primary document which includes the used attachment marker name, extracting an attachment index keys from the last used attachment marker, assigning a next available index value from the set of sequentially arranged index values which immediate follow the extracted index key of the last used attachment marker. After the attachment marker is generated, it is assigned to the supporting attachment, and inserted into the primary document.

In some embodiments, the method comprises generating a database containing one or more reference objects, each associated with a corresponding attachment marker inserted into the primary document, each reference object including a plurality of fields of object properties. The properties may comprise: an attachment marker name property, whose property value may be the attachment marker name of the corresponding attachment marker; the attachment marker index property, whose property value may be the attachment marker index key of the corresponding attachment marker.

In some forms, the properties may comprise one or more document information properties in relation to the referenced supporting attachment to which the corresponding attachment marker is assigned. In some forms, the properties may comprise a reference location property, whose property value is a location in the primary document where the corresponding attachment marker is inserted.

In some forms, the method comprises automatically updating the attachment markers currently assigned to the referenced supporting attachments, caused by (i.e., responsive to) a user-triggered invocation of the reference insertion or deletion function.

In some forms, updating the attachment markers comprises updating the database of reference objects to reflect a current state of the primary document, after invocation of the reference insertion or deletion function.

In some forms, updating the database of reference object comprises: generating a temporary data structure, the temporary data structure comprising a list of empty reference objects, one for each instance of reference which is made in the primary document; copying into the temporary data structure, property values for the reference objects in the temporary data structure, from the database to be updated; deleting all reference objects from the database of reference objects; resetting property values of reference objects included in the temporary data structure, on the basis of a current state of the primary document; copying reference objects included in the temporary database back to the database of reference objects; and updating an attachment marker place holder property value for each reference object in the database of reference objects.

In some forms, updating the database of reference objects comprises: generating a temporary database and copying into the temporary database reference objects included in the database to be updated; deleting all property values from the database of reference objects; resetting property values of reference objects included in the temporary database based on locations of references currently included in the primary document; copying reference objects included in the temporary database back to the database of reference objects; updating the attachment marker name and attachment marker index key property values in the database of reference objects, in accordance with the references currently included in the primary document; updating an attachment marker place holder property value for each reference object in the database of reference objects.

In some forms, the method comprises generating a reference register, and for each supporting attachment designated for collation with the primary document, adding a reference register entry. Each reference register entry may comprise the attachment marker assigned in respect of the corresponding supporting attachment.

In some forms, each reference register entry further comprises a document information relating to the supporting attachment associated with the entry, the document information comprising a number of pages included in the supporting attachment.

In some forms, the method comprises generating a reference index from the reference register, for inclusion with the collation of referenced supporting attachments.

In some forms, compiling the attachment documents designated for finalisation with the primary document comprises generating an attachment bundle. The attachment bundle may include one or more sets of bookmarks, each set of bookmarks comprising an attachment start bookmark and an attachment end bookmark, for insertion of one referenced supporting attachment there between, the sets of bookmarks being arranged such that supporting attachments are inserted in accordance with an order in which they are inserted and referenced in the primary document.

In some forms, the method comprises providing a primary document template function, for importing of a primary document content template, wherein an invocation of the primary document template function populates the primary document interface with a selected template.

In some forms, the method comprises providing an attachment bundle title page template function, for importing of an attachment bundle title page template to be used for generation of a page separating the primary document and the referenced supporting attachments.

In some forms, the method comprises providing an attachment title page template function, for importing of title page template to be used for generation of title pages for the referenced supporting attachments.

In some forms, user-invocation of the attachment title page template function is enabled, i.e., allowed, after a supporting attachment is designated for collation with the primary document, and a user-triggered invocation of the attachment title page function will cause a set of bookmarks, comprising an attachment title page start bookmark and an attachment title page end bookmark, to be inserted into said attachment bundle.

The attachment title page may be provided with a default or a modified attachment title. This may be a user-chosen option.

In some forms, the method comprises locking the finalised document. In some forms, the method further comprises unlocking the locked finalised document to edit the primary document or to edit instances of references included in the primary document, or both.

In some forms, the method comprises exporting the finalised document to another computing system. The method comprises, on the other computing system: importing the finalised document; extracting supporting documents from the collation and building a local library using the extracted supported documents; deleting the collation of supporting documents from the primary document; and enabling editing of the primary document. The imported finalised document may need to be unlocked before extraction of the supporting documents is allowed.

In another aspect, there is provided a document generation system, comprising a processing means, said processing means having access to a memory location having stored therein machine instructions, which when executed cause the processing means to provide the document generation method in any of the forms mentioned above.

In a further aspect, there is provided a computer readable medium comprising instructions which when executed cause a computer or a computing system to carry out the method in any of the forms mentioned above.

### BRIEF DESCRIPTION OF THE DRAWINGS

Embodiments will now be described by way of example only, with reference to the accompanying drawings in which

FIG. 1 schematically depicts a document preparation system provided by one embodiment according to the present disclosure;

FIG. 2 conceptually depicts an example of a program interface provided in an embodiment according to with the present disclosure;

FIG. 3 schematically depicts an example template importation process, in an embodiment according to with the present disclosure;

FIG. 4 schematically depicts an example interface which the system is configured to display, when the reference insertion function is invoked;

FIG. 5 depicts an example of a reference index provided in an embodiment according to with the present disclosure;

FIG. 6-1 depicts an example of a process for adding or deleting a reference object;

FIG. 6-2 depicts an example of process for updating the database of reference objects;

FIG. 7 depicts an example of a reference register provided in accordance with the present disclosure;

FIG. 8-1 depicts an example process for calculating the page numbering in the compiled document;

FIG. 8-2 depicts another example process for calculating the page numbering in the compiled document;

FIG. 9-1 depicts an example process for finalising or compiling the document;

FIG. 9-2 depicts an example workflow process which occurs when a second user imports a compiled document exported by a first user.

### DETAILED DESCRIPTION

In the following detailed description, reference is made to accompanying drawings which form a part of the detailed description. The illustrative embodiments described in the detailed description, depicted in the drawings, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Disclosed is a document preparation system for preparation of documents. The document preparation system will have particular utility in the preparation of documents in which support items of information need to be referenced, whether the supporting items of information are in the form of electronic documents or other electronic files. The documents in which references to supporting items are made are “primary documents”. The system can be used to prepare a document compiled from a primary document and one or more supporting items of information.

The technical functions provided by prior art systems do not always suit all types of documents, particularly the types of documents which require a collation, insertion, or both, of supporting information or attachments to be included with a primary document or report. Examples of such documents include, e.g., legal documents and affidavits, contracts, planning, Government and Corporate reports and others, that require the referencing, indexing and the collation of the supporting items as attachments to be included with the primary documents.

For instance, supporting items of various formats may be referred to in the primary document as “exhibit_1”, “exhibit_2”, etc, and attached to the primary document as attachment documents. The attachment documents may be individually identified to be to be authored or to be owned by a particular user (i.e., the author). For instance, an identifier to identify the author, such as an initial of the author, may be included in the attachment marker name, e.g., “initial_exhibit_1”, “initial_exhibit 2”.

In existing systems, functional attachment markers associated with the texts referencing the attachment documents will need to be manually inserted by the user in the primary document. Typically this is placed into the text at the location where the attachment document is referenced. This manual process would then continue for the next references made to particular supporting items. However, the main issue with this function is that while the supporting attachments or Exhibits in this example can be located, the author must individually save the attachment documents to a known file location by the author for later insertion, or if possible add a hyperlink to the file location and insert the hyperlink into the document. These paths are specific to the user's computing system and are not necessarily available in the computing system of another user who is collaborating with the authoring user. Or, in the scenario where the paths refer to locations on a server system, other users may need to be granted access to the specific locations on the server identified by the path or the hyperlink. However, different users for a server system may not necessarily have the same access rights to materials stored on the server.

The aforementioned manual process is also problematic as the user will need to manually track the names used for the references, particularly for systems where the sequentially assigned names for the references are used in the primary document. For instance, if the user removes a supporting attachment or adds a new supporting attachment, it may become necessary to reallocate and modify the attachment reference names used to refer to the supporting attachments within the Primary document.

This is a manual tracking process that has to be correlated with the reference in primary document, the title of the attachment document, a title page manually created and an aligning index.

In the presently disclosed system, any supporting attachments referenced in a primary document will be identified by unique identifiers known as “attachment markers”. As will be explained, the identifiers are updated as per required to correspond to user actions during the document preparation workflow. The automatic update is provided by the backend process of the document preparation system without the user needing to provide a hard-code, such as software systems based on LaTeX. Updates to the unique identifiers for the referenced supporting items, as well as any change as to which supporting items are included in the compiled document or the order in which they are included, can be made in different types of workflow, e.g., an initial generation of the document, or an author-review process for the document, or a review process by a collaborator who is not the author, from the collaborator's own computing system.

The document preparation system will combine the main document and any support item(s) into a compiled document. The supporting items of information will appear in the order in which they are inserted and referenced in the main document, at any point during the document preparation workflow. References to the supporting items will further be dynamically linked with the pagination of the overall compiled document, during the document preparation workflow. The compiling of the document to set the pagination may be performed once the finalisation function is chosen by the user.

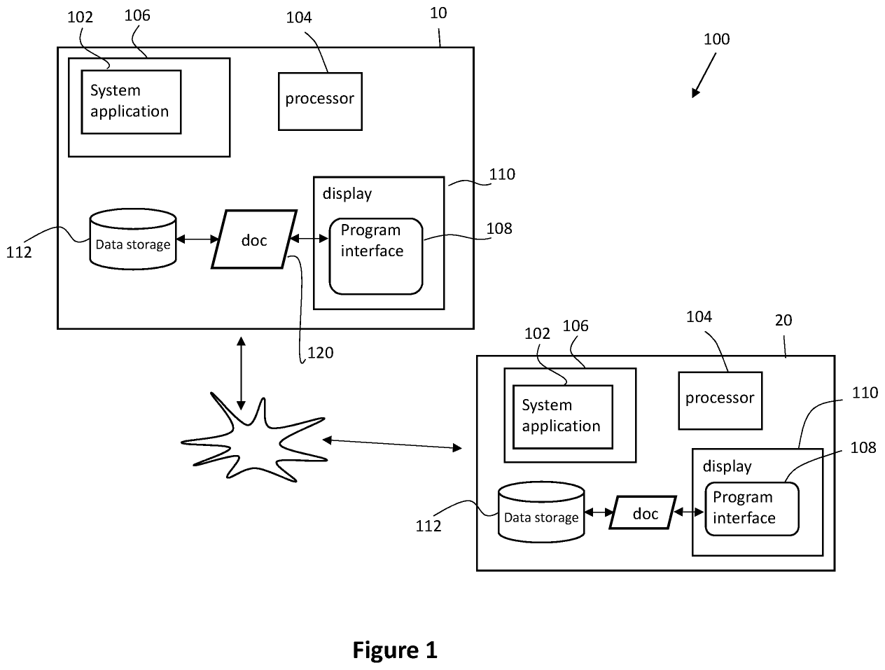

FIG. 1 schematically depicts a document preparation system 100. The system 100 includes a system application 102, executable by the processor 104 of a user's computing device 10. The system application 102 may be implemented as an application module or a collection of modules. Computer readable instructions which are executed to run the application 102 reside in a memory device 106. In FIG. 1, the memory device 106 is shown to be collocated with the processor 104. However, it may be remote located and accessible by the processor 104. The system application 102, when executed, will launch on the computing device 10, causing the display of a program interface 108 on the display hardware 110 of or connected to the computing device 10. From within the program interface 108, users can generate documents. The document may be created without a template or a template may be imported into the program. From the document, one or more supporting items of information may be referenced. The templates the supporting items of information may be stored on a data storage 112 accessible by the processor 104.

The created document 120, comprising a primary document and, if included, any supporting attachment which is referenced in the primary document, can be stored in the data storage 112, and then re-imported into the program interface 108 for further actions such as editing actions. The two-way process to provide the exporting and importing, is expressed by the two-way arrows included in FIG. 1. As will be explained later, the supporting attachments will be saved into a document or “library” which is associated with the primary document. The created document 120 may be transmitted by the user using any existing communication protocol to another computing device 20, on which there is also installed an instance of the program application, for further editing. After all edits are finalised, the document may be saved into a read-only file from the program interface and then saved into data storage. The read-only file can then be provided as the final output.

In FIG. 1, two computing devices 10, 20 are included in the system. However, a single device, or three or more devices, may instead be provided. The computing devices 10, 20 are each shown to have their own local data storage and local processors. However, for the purpose of the document preparation system, one or more of the devices may be a server or part of a server arrangement of a computing network, where access to the computing network may be gained from a web-based application or a secure direct access portal, e.g., from a virtual desktop. This allows a user to access the document preparation system being run on the server via a local device without the program application be installed as a local native application.

The program may be configured to provide user interfaces and front-end functions, such as those mentioned below. The skilled person will understand that there can be variations to the user interfaces and functions described, as permitted by the implementation of the program algorithm and the creation and manipulation of data objects, which will be described later.

### Front End and Interface Description

### Example Program Interface

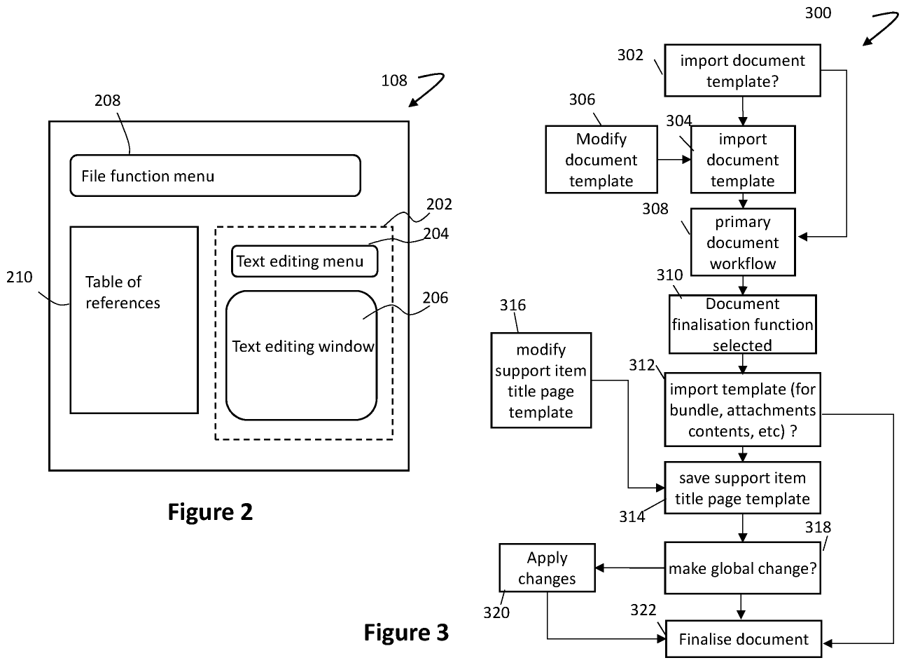

FIG. 2 conceptually depicts an example of a program interface 108, in which users can create or edit a primary document. The program interface 108 provides a text editor window 202, with a text editing portion 204 in which text can be added or texted. In this example the interface 108 also includes a text editing function access portion 206 where various text editing functions can be accessed. The program interface 108 includes a file function menu 208, which enables the user to access file control functions, such as opening files, saving files, “finalizing” a file to generate a compiled document comprising the primary document and the supporting item(s), etc. The program interface 108 may further include a reference review portion 210, in which a listing of the referenced supporting items and where references to these items appear in the primary document, can be displayed.

The program interface 108 may change the display arrangement in response to access to particular functions provided in the program. For example, after a user accesses the “finalise” or “compile” function, the text editor window 202 may be replaced by a document view window showing the finalized view of the compiled document. When the user accesses a reverse function to “un-finalise” the document, the document view window may be replaced by the text editor window 202.

### Primary Document Template Importation Function

The system may be configured to enable a template to be imported into the current work flow, for the user to prepare a document using the template. The template can be one that was generated in another program. In the absence of a template being available or a template being selected, the program permits the user to directly prepare a primary document without the use of a template.

In embodiments where templates can be used, the system is configured to access a data storage system on the computing system or computing device where the system is installed, in which one or more templates are located, for the user to select a template for importation for use in the document preparation system.

For example, within the program interface 108, a user can access a function menu to add a new document. The function menu may be presented as part of the interface (e.g., file function menu 208 in FIG. 2), or may be accessible by the user right clicking the mouse. When the function to add a new document is chosen, this triggers a window portal or a file selection dialog box to be displayed, in which the user is enabled to search through the data storage system of his or her computing device or the data storage system on a server location, to select a template. The system is configured to, on the confirmation of the selection, make a copy of the template and apply it into the work flow interface portion (e.g., text editor window 202 in FIG. 2). The user can then set a name for the new document, for saving within the memory location for the program.

### Attachment Bundle & Title Page Template Importation Function

In some embodiments, the system is configured to enable the user to import title page templates. The title page templates may be imported prior to the user inserting a reference to a supporting attachment into the primary document. In other embodiments, the insertion of a template occurs during the finalisation phase of the workflow.

If a title page template is used, in the compiled document the supporting attachments will appear following their respective title pages. A default setting may be utilized, if no title page template is included. For instance, the supporting item title page template may be imported from a Statutory Declaration format, or a template including a company logo or emblem. The imported template may be one which was set in a different editing or viewer program, such as Word, PDF, or Google Docs.

Preferably, the system is configured to enable the user to modify the title page template, prior to it being accepted and utilised within the document being prepared. Further, the modification made be restricted to just the title page for the current supporting attachment being inserted or may be applied to the title pages for all supporting attachment(s) which will be inserted.

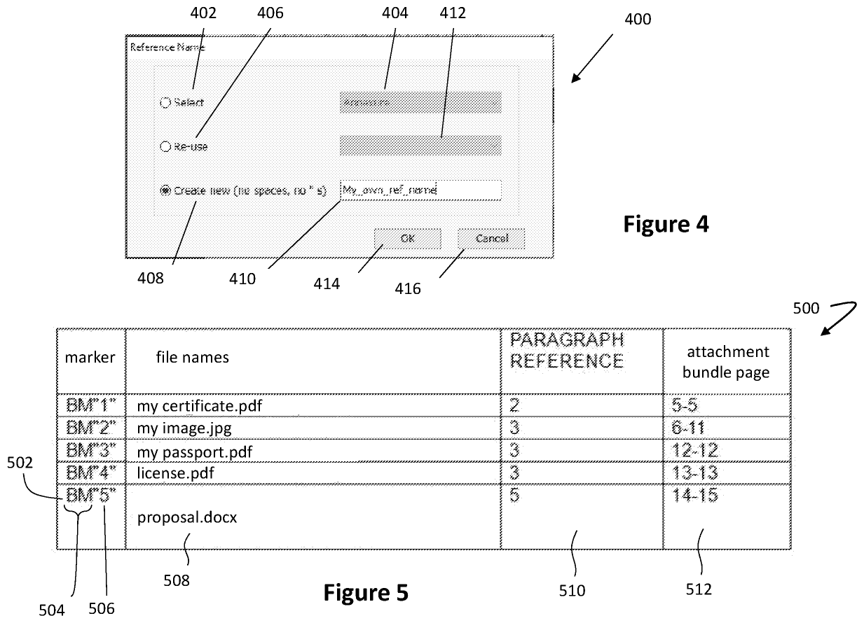

FIG. 3 schematically depicts an example template importation process. This process assumes that no templates are already available within the system's allocated memory. At step 302, which occurs prior to the start of the document generation workflow, the system obtains a confirmation from the user whether a template is to be used. If a template needs to be imported, at step 304, the selection of the template will cause the system to save a copy of the template, in a memory location allocated to the document preparation system. The template may be accessible by the system from a local or remote data storage and duplicated by the system, or may be accessible by being downloaded from a web-based location. The duplicated or downloaded copy is saved into the system's allocated memory location. This template will be for use from within the document preparation system to generate a primary document. In preferred embodiments, the importing of a template document will be cause it to be automatically utilized for the primary document to be generated.

At step 306 the copy of the template is renamed, or modified, or both, if the user chooses to do so. The document generation workflow (step 308) then starts. If the user chooses not to use a document template, the workflow process starts (step 308) without a template being applied.

In some examples, when the user invokes the function to finalise the document, he or she will be able to select to use a template to create a title page for each of the referenced supporting attachments. In these examples, any title pages will be taken into account in the pagination which will be applied to the overall finalized document. The pagination is described in more detail later in this document with reference to FIGS. 8-1 and 8-2. The remaining steps in FIG. 3 provide an example of the template insertion process.

At step 310, the user chooses to finalise the document. At step 312, the system determines whether to import a title page template which is to be used for the title page generation for the support attachments referenced in the primary document. In this embodiment, the option to use a title page template and the selection of the title page template is offered to the user and set during the primary document preparation process (step 308).

At step 312 the system may additionally or alternatively determine whether to import an attachment bundle title page template. For this step, the system will obtain a confirmation from the user as to whether an attachment bundle title page template is to be used to separate the primary document from the supporting attachments. If the user does not select to use a template, the process proceeds to the finalization procedures at step 322. If a template is to be used, at step 314, the system will access it by saving a copy from a remote or local storage location, or by downloading and saving a copy from, e.g., a web-based location. The saved copy be saved into a format recognizable by other programs, such as PDF, Word, Google Docs. At step 316, the system allows the imported template to be modified if this is chosen by the user. At step 318, the system determines whether the modification is to be applied for the title pages for all supporting attachments. At step 320, the modification is set to be applied to all support item title pages if this is selected by the user. The process then proceeds to the finalization procedures (step 322).

Where applicable, saving a document template or a support item title page template into the document preparation system, means that any fields used for automated text generation, such as automated cross-reference data generation, will be replaced by attachment markers generated from the document preparation system.

If the finalised document is “unfinalized”, i.e., re-opened for editing, at a later time for editing by the user or another party, the title pages may be removed. The program may seek user confirmation whether to use the templates again, and if confirmed insert the template(s) into the compiled document, when the finalization function is again chosen.

### Adding and Removing a Reference Within a Primary Document

The system is configured so that the insertion function to insert or add reference a supporting document can be invoked. The invocation may be performed using a command entered by operating a hand-operated input hardware, such as a mouse or a mouse pad, e.g., by right-clicking to bring up a function menu, and selecting the function to insert a reference.

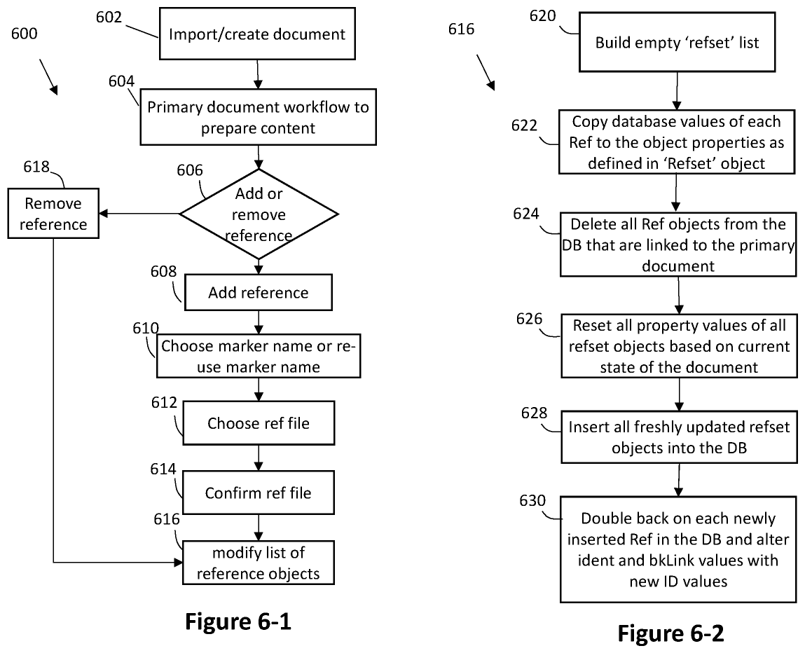

FIG. 4 shows an example of the interface 400 which the system is configured to display, when the reference insertion function is invoked. The interface 400 includes a plurality of elements for the user to search for and then set the supporting attachment to be referenced. These may include a “select” element 402, the selection of which causes the system to display a list of pre-set names 404 from which the user can choose as the “attachment marker name”. The “attachment marker name”, as will be described later, is used to set up a new attachment marker to refer to a supporting attachment for the first time. The interface 400 may further include a “create new name” element 408, the selection of which will enable the user to enter a user defined attachment marker name in an attachment marker name entry field 410. The interface 400 may further include a “re-use” interface element 406. The selection or activation of the re-use field 406 will trigger the interface 400 to display a list of attachment markers 412 which are current in use in the primary document. The re-use field or element 406 is used when a subsequent instance of reference is to be made to a supporting attachment to which one or more instances of reference are already included in the primary document. However, it will be appreciated that the same attachment document will only be included in the overall bundle of the finalised document once.

Selection of an interface element to set an attachment marker name (select element 402 or create new name element 408) and setting the attachment marker name, or selection of the element 406 to re-use an attachment marker name and choosing the attachment marker name to re-use, may enable a confirmation button 414 on the interface 400. Activation of the confirmation button 414 confirms the attachment marker name, or confirm the attach marker.

If the confirmation button 414 is activated while an interface element for setting the attachment marker name (402 or 408) is chosen, this may further cause the document preparation system to display an interface (e.g., a search window) to allow the user to navigate within the data storage system to identify the supporting item of information to be referenced. The program may be configured to launch a view window for the user to view the identified supporting item of information. The user may be provided with an option to confirm the viewed document is the intended attachment to be referenced. Or the user can return to another search window should this viewed document not be the one that is required.

In preferred embodiments, confirmation of the choice of supporting item will trigger a number of actions. A copy of the supporting item will be made as a supporting attachment and included into a local library of supporting attachments. The local library of supporting attachments is or will have been created specifically for the particular primary document, to only include one copy each, of the one or more supporting attachments referenced in the primary document. The system will further automatically assign an attachment marker key. The action to automatically assign the attachment marker key may in some cases be a part of an overall recalculation or update of the attachment marker keys of all of the attachment markers. An attachment marker is generated using the attachment marker key and the attachment marker name. A unique attachment marker is associated with each supporting attachment. The system may further add the attachment marker to the reference register. The attachment marker is inserted into the primary document.

If the confirmation button 414 is activated while an interface element for re-using an existing attachment marker 406 is selected, the chosen attachment marker will be inserted into the primary document.

Thus, the confirmation button 414 may be implemented as a macro, where the function or functions to be activated by the macro depends on which of the interface elements 402, 406, (and element 408 if included) is previously selected.

The system may be configured such that, when the user wishes to delete a reference from the primary document, the user can place the cursor anywhere within the specific attachment marker which they wish to remove, the attachment marker having been inserted in the primary document when the reference was initially added. With the cursor in this location, the user can select to delete the reference. For example, the reference deletion function may be invoked by the user right-clicking the mouse to bring up a function menu, and selecting the function to delete the reference at the cursor location. The deletion will cause the removal of the particular instance of reference to the corresponding supporting attachment in the reference register, in embodiments where the reference register is provided. Further, the program will re-allocate attachment markers for the still included supporting attachments automatically. By the re-allocation the system automatically correlates the attachment marker key (typically a value of the alpha or numeric, or alpha-numeric numbering system) used to generate the attachment markers to the revised order in which the supporting attachments are referenced in the primary document. This is done without the user having to manually undertake this process.

### Supporting Attachment Collation

The system may be configured to collate the supporting attachment or supporting attachments referenced in the primary document. The system is further configured to automatically position (i.e., order) the attachment documents in relation to each other, in accordance with the positioning of the corresponding referencing text within the primary document. The system is further configured to compile the collation with the primary document. The compilation will cause the collation to be attached to (e.g., appended to or linked to) the primary document, so that the collation and the primary document become parts of the same transmissible file. The manner of attaching may differ in different embodiments. In one embodiment, copies of the selected supporting items will be kept separate from the primary document. The copies will not be visible from the front end (i.e. to the user), but will be merged with the primary document when the collation is being finalised and then become visible. In another embodiment, copies of the supporting items will be directly appended to the primary document during the work flow and will be visible. In a further embodiment, copies of the selected document will be combined with each other, but remain separate from the primary document. The copies of the selected documents will appear in the order of respective first reference/appearance of their associated “attachment markers” in the primary document.

As mentioned before, the copies of the supporting items (i.e., supporting attachments) will be saved into an internal memory location (e.g., sub-folder) allocated to the program application. Thus, the copies will not be affected by a change to their original source locations. Each compiled document file will have a transmittable copy of the primary document, and if included, copies of the supporting attachments included in the sub-folder location. The sub-folder path for each supporting attachment is defined by the program application and will be embedded in the backend of the primary document. This allows the user to recall a supporting attachment from within the primary document. Thus, when the compiled document file is sent to the computing system of a different user, the library can be replicated when the document file is opened for editing within an instance of the program application on the other user's own computing system.

As alluded to above, the program application is configured to, when a compiled document is opened within the program, allow the user to unlock the compiled document. The unlocking may cause the primary document and the supporting attachment(s) to disassemble. The supporting attachments, title pages for the supporting attachments, and the reference markers, will be automatically reproduced as required by the editing in the workflow, and re-assembled accordingly during the finalisation process.

### Generation and Display of a Reference Index

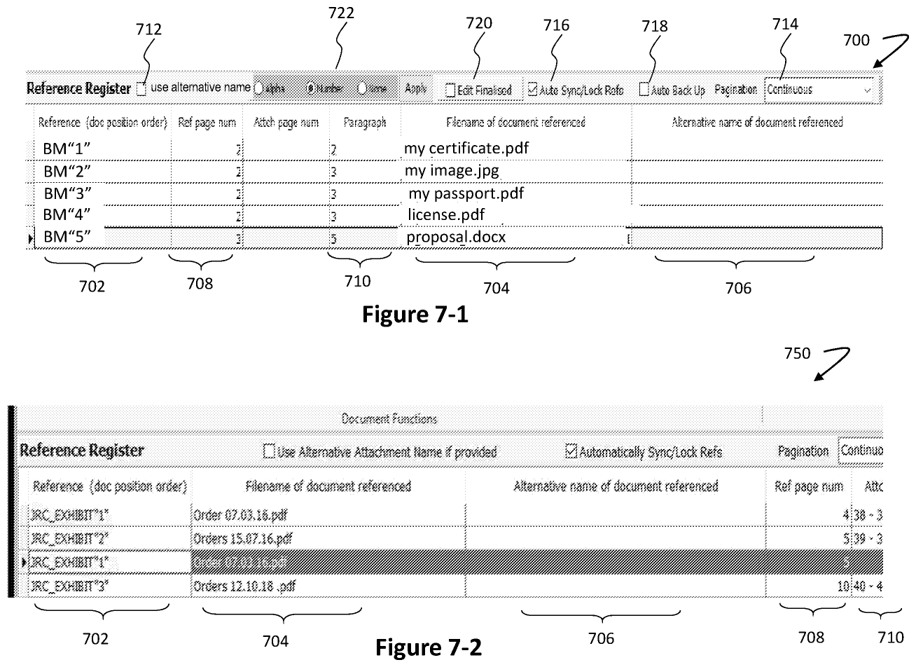

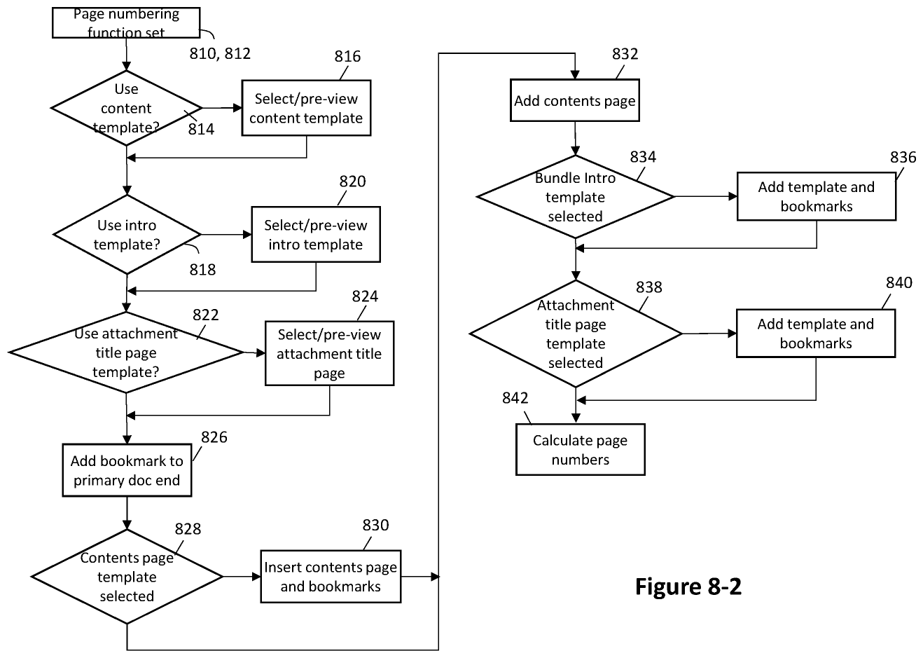

At the time of document compilation, the information from the reference register (described below with reference to FIG. 7) may be used to create a reference index. An example of a reference index 500 is shown at FIG. 5. A reference index generally includes at least a list of the supporting attachments referenced in the primary document. Where title pages for the supporting attachments are included, the reference index identifies the titles as provided for the title pages, and the attachment marker automatically allocated to the associated document. Thus, the name used to identify the supporting attachments in the reference index may be the same as the attachment markers. Or, it may be the alternative name assigned to the supporting attachment at the time of insertion of the supporting attachment by the author, if an alternative name was assigned.

The reference index may be displayed on the user interface. Additionally or alternatively, the reference index may be included as a part of the compiled document. Where included within the compiled document, the index may be located between the end of the primary document and the start of the supporting attachments. The reference index may alternatively be located elsewhere in the compiled document. The positioning of the index table may be selectable by the user.

The reference index is also configured to display the page number or the paragraph number (if used) of the primary document, where the supporting attachment has been referenced. This information can be obtained from the reference objects which are data objects associated with each instance of a reference made in the primary document and which will be described later in the disclosure. Thus, the location information of each of one or more instances of reference made can be automatically included into the reference index.

The reference index may be further configured to display a pages range within the finalised document or within the supporting attachment bundle. The page range for each supporting document may start from a title page inserted from the document preparation system, for the supporting attachment.

FIG. 5 shows an example of a reference index 500. The reference index 500 is here shown in a table format, but other formats may be used.

The reference index 500 identifies each supporting attachment by their unique attachment marker 502. In the depicted example, five attachment markers are shown, including “BM1”, “BM2”, “BM3”, “BM4”, and “BM5”. These may also be used as the titles on the title pages for the attachments.

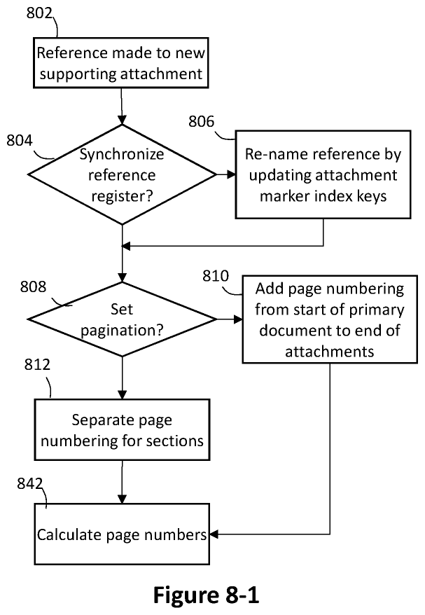

Each attachment marker includes two components. One component is the attachment marker name 504 which may be set in the process shown in FIG. 6-1 at steps 606 to 610. Referring back to the example shown in FIG. 5, the attachment marker name is “BM” for all attachments. The other component is a number value 506, which is sequentially assigned to the supporting attachments they are inserted into the document. Here, the attachment numbers are “1”, “2”, “3”, “4”, and “5”, respectively in BM1″, “BM2”, “BM3”, “BM4”, and “BM5”. The sequence of the number reflects to the order in which the attachments are referenced. That is, BM1″, “BM2”, “BM3”, “BM4”, and “BM5” are the 1^{st}, 2^{nd}, 3^{rd}, 4^{th}, and 5^{th} reference documents that have the attachment marker name “BM”, respectively.

In this example, the index 500 further identifies the file names 508 of the supporting attachments as they were saved on the data storage system.

The index 500 may identify the location of where each reference made in the primary document, such as the page number or paragraph number where the reference is made. In this case, a column 510 in which paragraph numbers are provided, is included.

In addition to the above information, the index 500 may also provide a page range 512 for each supporting attachment, to identify the pages in the compiled document or the pages in the compiled bundle of attachments, where the support attachment is shown.

### View Function and Return Function

The document preparation system may be configured to link the attachment markers included in the index or in the primary document to a view function. By selecting a particular attachment marker in the index or the primary document (e.g., by right-clicking), the supporting attachment associated with the attachment marker will be displayed. The view function may involve a pop-up display function where the supporting attachment is shown in a pop-up window. The view function may involve a scroll function, where the display screen shows the document being automatically scrolled to the position at the start of the supporting document. The cursor may also be moved from the original position pointing to the attachment marker to a new position at the start of the supporting attachment, or a new position at a title page for the supporting attachment. Both types of view functions may be made available, so that the user can select whether to scroll to the attachment document or view it in a pop-up window. The selection may be invoked by the user accessing a macro which becomes available by a user action, such as by pointing the cursor to the attachment marker and right-clicking. In some embodiments, the system is further configured to, once the supporting attachment is shown in the window, automatically move the cursor to the commencement of the document of the displayed attachment. This saves the reader having to spend time scrolling through potentially voluminous documents.

The above mentioned “view” function, invoked when the user makes the selection to view the supporting attachment from within the primary document, may further enable a “return function”, such that the return function can be accessed once the scroll or display function is performed. In enabling the return function, the system is configured to pass to the return function the original position of the cursor in the primary document where the view function was called in the first place, as an input. The original position value may be included as one of the object properties of the reference object attached to the reference marker. The system simply passes the position property value as an input to the “return function”. When invoked, the return function will cause the cursor to return to that original position.

### Data Objects and Reference Data Objects

In the below, various reference objects and data objects created by the program are described.

### Attachment Markers

As mentioned above, the system is configured to generate a unique “attachment marker” for each supporting attachment referenced in the primary document. Each attachment marker is generated from at least an attachment name and an attachment marker key. The attachment marker may be a concatenation of the attachment marker name and attachment marker key. The attachment marker associated with the supporting attachment being referenced will appear as a text inserted into the current cursor location in the primary document.

Thus, the attachment name refers to a name assigned to the supporting attachment being referenced. The attachment marker name may be automatically set by the system. For instance, the system may be configured to automatically generate an attachment marker name on the basis of an identifier for the user (e.g., an identifier, a user name, or a user initial), or the type of attachment that the supporting item is (e.g., declaration, email, photograph, invoice, etc.), or both. Alternatively, the attachment marker name may be chosen by the user. The system may further enable the user to modify the attachment marker names assigned to the supporting attachments.

When the user inserts a reference to a supporting attachment in a primary document, the supporting attachment is made as a copy of a supporting item selected from the document storage system, as described previously. At the time of inserting a reference to a supporting item, an attachment marker name is selected or entered by the user using the program interface, and where applicable, an alternative name may also be entered by the user. The entered information will be used to generate the “attachment marker name” associated with the supporting attachment made from the supporting item.

The other part of the attachment marker is the “attachment marker key”. The “attachment marker key” is set in accordance with the order of appearance for the specific supporting attachment in the primary document. The order is in relation to all of the supporting attachments mentioned in the primary document that use the same “attachment marker name”. Thus, the order may be the order in relation to all supporting attachments or only a sub-set of the supporting attachments, depending on whether different attachment marker names are used.

The “attachment marker key” will be automatically assigned in accordance with the primary document generation workflow. In some circumstances, changes made to the document during the workflow will affect the order in which a particular supporting attachment is referenced in comparison to other supporting attachments whose attachment marker uses the same attachment marker name. The system is configured to automatically update or reassignment of the attachment marker key for each supporting attachment, when such changes occur.

The attachment marker key will be preferably assigned according to a chronological or ordered system, such as but not limited to “1, 2, 3, . . . ”, “i, ii, iii, . . . ”, or “a, b, c, . . . ”. For example, in a chronological system of positive integers as attachment marker keys, a first supporting attachment referenced will be assigned a first marker key “1” in the chronological system, a second supporting attachment referenced which is different than the first supporting attachment will be assigned a second marker key “2” (e.g., increment index by 1), etc. If references to the first supporting attachments are deleted, then the second supporting attachment will now have the attachment marker key “1”, as it becomes the supporting attachment which is referenced first in the document.

In some embodiments, every time a reference to a new supporting attachment is added to the primary document, and every time a reference to a supporting attachment is deleted from the primary document, the document preparation system will reassign all of the attachment marker keys for the supporting attachments still referenced in the primary document that have the same attachment marker name.

According to the above, a new, unique, attachment marker will be generated for a supporting attachment is referenced for the first time in a primary document. If that same supporting attachment is referenced again later in the primary document, the same attachment marker will be used in respect of the sequent reference or references to the supporting attachment. The program is configured to provide the user the option to include each supporting attachment document into the document bundle for the finalized document only once regardless of the number of times the supporting attachment is referenced, to avoid duplication.

For example, all of the supporting attachments may have attachment marker with the format user name-exhibit-attachment marker key. Thus, the first, second, and third supporting attachments referenced may have the attachment markers user name-exhibit-1, user name-exhibit-2, and user name-exhibit-3.

In another example, the supporting attachments will have attachment markers in the format owner name-photograph-attachment marker key, or owner name-invoice-attachment marker key, depending on whether the supporting attachment is a photograph or an invoice.

In limiting examples where each supporting attachment has a unique attachment marker name, they may have the same attachment marker key, e.g., all being “1”, “a”, “I”, etc, or the attachment marker key may be omitted.

### Library of Supporting Attachments

The document preparation system is configured to generate a local library of supporting attachments. This may be provided as a data set or as a sub-folder in the data storage location assigned to the document preparation system application. Each document being prepared may have its own dedicated library saved at a dedicated sub-folder.

The library may be an empty library if no supporting attachments are included. If a reference needs to be made to a supporting item of which a copy does not exist in the library, the systems save a copy of the supporting item, as a supporting attachment, into the library. During the document work flow, from the program interface, references can be made to supporting attachments in the library, and added to the primary document.

The supporting item of information may be a file which is located in a local or a remote data storage accessible by the program application. Thus, the system is configured to access the data storage, to obtain a duplicate of the referenced supporting item of information, and include the duplicate in the “supporting attachments” library. From the user's point of view, the system provides an access to navigate the remote or local data storage, or the internet, for the user to select the required item, and then the system will save a copy of the selected item as a supporting attachment into the supporting attachments library.

The copy saved into the library will reflect the content or version of the supporting item at the time of inclusion. If the supporting item is subsequently modified, the modification will not be duplicated in the supporting attachment in the local library. Similarly, if the support item is deleted or relocated from the original file location in the remote or local storage system, the supporting attachment remains accessible from the supporting items library.

The library provides a data source for the various attachment to be appended to or inserted into the primary document, or for the generation of a supporting attachment bundle, which includes the attachments referenced in the primary document but arranged according to the order in which they are referenced. The supporting attachment bundle can appear as appended pages to the primary document or be a separate object linked to the primary document. Also, at the time of inclusion into the library, a path to the document copy in the library location is assigned to the supporting attachment. Thus, the library may alternatively or additionally provide a data source so that copies of attachments contained therein can be recalled by the user from the primary document, e.g., by selecting the text for attachment marker in which a link defined by the path will be embedded. The recall function may also be provided elsewhere, e.g., in a reference register being displayed in a part of the user interface provided by the program, as long as the link pointing to the path is embedded therein.

The finalised file will include the attachments, either as appended or inserted documents which are collated with the primary document, or as a separate bundle. When the finalised file is transmitted to be opened by another user on his or her own computing system, the copies of the supporting attachments included in the finalised file will be used to populate into a local library accessible by the instance of the document preparation system on the other user's computing system.

In some embodiments, it may still be possible for a user to send the unfinalised file to a collaborator. However only manual adjustment to the attachment markers will be possible, due to the user requirements that the software does not automate the markers.

### Reference Objects

The system is configured to generate a data structure to hold information in relation to, and thereby internally represent, each instance of reference to a supporting attachment, made in the primary document. For simplicity this is referred to herein as a “reference object”. Each supporting attachment is stored as a data object, such as document object, in the memory accessible by the system, e.g., in the local library. The reference object may be a structured array, including a plurality of fields.

These fields may include property fields to specify which supporting attachment is referenced, and may include a pointer to point to the document object (i.e. the referenced supporting attachment). The pointer may “point to” the location of the supporting attachment in the local library.

The properties specifying the supporting attachments being referenced may include those to identify the supporting attachment associated with the reference object. These may include an attachment marker name property and an attachment marker key property, whose values duplicate the attachment marker name value and the attachment marker key value of the attachment marker associated with the referenced document object (i.e., referenced supporting attachment).

The document preparation system is configured to associate the referenced document objects with the primary document. The association may be done by embedding a link which points to a reference object at the location where the attachment marker for the reference object is inserted in the primary document.

The data structures for the reference instances may be saved into a list. Prior to any reference to a supporting attachment being made in the primary document, there are no reference instance data structures objects and a reference list would be a null list. Each time an instance of reference to a supporting attachment is made, a data structure for the reference instance will be added to the list.

In an example, a structured array for each reference instance may comprise the following object properties.
“Attachment marker key”
“Attachment marker name”
“Unique identifier”—this is the unique identifier assigned to each reference instance in the list of reference instances. It may be the unique database identifier value for the data structure in the table (or list) of reference instances. However, it may alternatively be generated by concatenating the database identifier value with a unique code or string (e.g., “#*_ 5”). The unique string is thus used, preferably as a pre-fix. It helps to ensure that the resulting “unique identifier” will not be inadvertently the same as another bookmark or string value included in the document being prepared. For instance, a purely numerical string may by chance duplicate numerals in a postal code or a telephone number. Adding the prefix value reduces the likelihood of such occurrences.
“File Name”—a string value representing the actual file name of the supporting attachment as saved in the local program memory; may be copied from the file name of the supporting item of which the supporting attachment file is a duplicate.
“Alternative Name”—a string value representing a name assigned by the user as an alternative to the attachment marker for the supporting attachment. This is not required in all embodiments.
“bklink”—the value of this property is copied from the value of the “unique identifier” property, after the “unique identifier” property is set or re-set. This property is intended as a placeholder for the “unique identifier” for the first instance of reference to the same supporting attachment being referenced in the current instance of reference. It will be updated if the attachment marker is updated due to the user insertion or deletion of a reference in the primary document. It will be appreciated that the concept of using a placeholder may be generalized. For example, the “bklink” property, instead of holding the “unique identifier” property value, may instead hold the “attachment marker” value of the referenced supporting attachment, or it may hold a combination of the “attachment marker” with a reference location value.

The distinguishing object properties for the reference objects may be object properties representing the location of the reference object in the primary document. The location may be defined by one or more of page number, paragraph number, line number, etc., set by the current cursor location at the time the reference object is included.

The object properties may include one or more properties to characterize the supporting attachment itself, such as:
“File Type”—a character string defining the file type, for instance, potential values can be the extension of the files, such as “.docx”, “.pdf”, “.jpg”, “GoogleDocs” etc.
“File Location”—a character string defining the physical location on the data drive (i.e., path) where the supporting attachment is stored.
“Placement”—where the supporting attachment will be located in the compiled document. This may be a page number or a range. This enables the user to directly navigate to the supporting attachment from the reference object. For instance a supporting document may be located at pages 20 to 25 of a compiled document. The compiled document may have two series of page numbers, where one series of page number starts at the beginning of the primary document, and then another series of page numbers starts at the beginning of the attachment bundle. Alternatively, the pagination may restart for each section (e.g., primary document, attachment 1, attachment 2, etc.) of the finalized document, or the numbering may be continuous. Each attachment may have its own series of pagination. For example supporting documents exhibit-A and exhibit-B may use the page numbering system A-1, A-2, A-3, . . . , etc., and B-1, B-2, B-3, . . . , etc. further alternative—separate bundles for different types of attachments.
“reference location”—this defines where the instance of reference is made in the primary document. For instance, the “reference location” property may comprise at least a page number of the page where the instance of reference is made.

It will be understood that not all of the above properties need to be included. Further properties which identify the supporting attachment, characterize the supporting attachment, distinguish between reference objects, or characterize where in the primary document the reference object is included.

Values of the property fields of the reference objects allows for the various functions by the document preparation system. For example, the system is configured to use the values of the object properties of the reference objects to create the reference index or generate the reference register, described with reference to FIG. 5 and FIG. 7.

Reference objects generated during a document work flow will be retained in a reference database. The reference database may be temporary retained within a working memory location assigned to the program, or it may be stored in a data storage location dedicated to the document being prepared.

As will be explained with reference to FIG. 6-1 and FIG. 6-2, the properties of the reference objects will allow the automatic updating of the attachment markers to be made, so that the attachment markers will always reflect the order in which their associated supporting attachments are referenced in the primary document.

FIG. 6-1 depicts an example of a process 600 for adding or deleting a reference object. At step 602, the user initiates a document workflow. This may involve importing an existing document which will have a primary document portion, and which may have an attachment bundle (e.g. if the imported document file is a compiled document file including supporting attachments). Or the document workflow may be initiated by creating a new document. At step 604, the user starts the workflow to prepare or edit the primary document. At step 606, the user may choose to add a reference by inserting an attachment marker, or delete a reference by deleting an attachment marker in the primary document. At step 618, the user deletes a reference. This leads to step 616 where the list of reference objects is modified. Or, at step 608, the user adds a reference. At step 610, the system enables the user to choose an existing attachment marker name to reference an existing supporting attachment, or enter a new attachment marker name. At step 612, the supporting attachment file is chosen. This may be done by the user confirming the choice of the re-used attachment name, or by the user choosing and confirming a supporting item to be copied. In the latter case, the system may be configured to enable the user to navigate the data storage of the computing system, via an application interface which displays a window portal or file selection dialogue box, to choose a supporting item to copy. Optionally, at step 614, the system will display the chosen supporting attachment or chosen supporting item, either in a display portion of the program interface or in a pop-up interface, and prompt the user to finally confirm whether the displayed document is the one the user intended to reference. At step 616, the system modifies the database of reference objects, to add the new reference object corresponding to the new instance of reference, and make other required updates.

FIG. 6-2 depicts an example of how the database of reference objects may be updated. At step 620, the system program builds a temporary “refset” list to have one object for each instance of reference currently in the primary document, for which the object values are initially empty. At step 622, all of the property values of each reference object currently in the reference object database are copied to the corresponding temporary list. Thus the temporary list will have reference objects currently included within the primary document however the values copied into the objects are property values from the database to be updated. At step 624, the system program deletes all reference objects from the reference object database.

With the insertion or removal of an attachment marker in the primary document, the total number of reference objects is also changed in the primary document. There may further be other changes. For example, the positions (in the primary document) of the other attachment markers and associated reference objects may be shifted. Or, the order in which the attachment markers and reference objects will be included in the primary document may now be different. Thus, at step 626, the system program resets the relevant property values the reference objects in the temporary list, based on the current state of the primary document. The association of the “attachment marker name” and “attachment marker key” values with the “filename” or “file location” values, by the respective properties belonging to the same reference object, allows the program to ensure there remains a one-to-one relationship between the supporting attachment and the attachment marker.

At step 628 the reference objects in the temporary list are copied into the reference object database to repopulate it. At step 630, the system program “doubles back”, to update the “unique identifier” and “bklink” values for each reference object, with reassigned unique identifiers (e.g., which could be assigned based on the new order in which the reference objects occur). Once these final updates are done, the repopulated reference object database correctly reflect the state of the reference instances included in the primary document.

### Reference Register

The system is configured to create, for display, a register of the references to the supporting attachments made in the primary document. The reference register may display every added instance of reference with information about the reference, such as: the attachment marker name or the file name of the referenced supporting attachment, the page and paragraph it appears on, the name and location of the attached file and any alternative name opted for to describe that file in the document.

An example of a reference register 700 is shown in FIG. 7-1. In this example, for each supporting attachment, the reference register 700 will include several properties. These include the “attachment markers” 702 assigned to the supporting attachments, which will be of the same as the supporting attachment's unique attachment marker. The reference register 700 will also reflect updates made as to what supporting documents are referred to in the primary document.

The reference register 700 may further include the file names 704 of the supporting attachments as they were saved on the data storage system. Potentially, the reference register 700 will also include any alternative names 706 which the user has set to refer to the supporting documents. For instance, renaming may be done to suit formatting requirements, or to remove sensitive information in the file name. In the reference register 700 shown, the alternative names fields 706 are empty as no alternative names have been set for any of the supporting attachments. This field does not need to be a part of the reference register 700 in all embodiments.

The reference register 700 further identifies where the supporting item is referenced in the primary document. In this example, the reference register 700 includes a page number field 708 and a paragraph number field 710, etc. It will be appreciated that the page number field 708 and the paragraph number field 710 do not need to be both included. Other fields to indicate the location of the reference made can alternatively or additionally be included.

In this example, the reference register 700 further includes an attachment page number field 722, to identify the specific page of the supporting attachment that is being referred to in the primary document. The specific portion of the portion being identified in this field needs not be a page. It may, for instance, instead be a paragraph number in the attachment document. The inclusion of this field is optional and is not necessary in all embodiments.

The values included in the reference register for each supporting attachment may be the same as the values of the corresponding properties of the reference objects referring to the supporting attachment.

The reference register may be displayed on the user interface as a tool to help the user keep track of what supporting attachments have been referenced in the primary document. The display may only occur when an index generation function is invoked by the user, or the program may automatically display the reference register in an interface portion of the program interface.

The displayed reference register may be modifiable from the user interface. For example, to opt for an alternative name the user may simply type the preferred name directly into the corresponding grid location for the reference. Referring to the embodiment shown in FIG. 7-1, the action of typing the alternative name into the reference register 700 may instantiate the alternative name. However, to enforce its use, the user may need to confirm the selection to use the alternative name, such as by ticking the ‘Use Alternative Name’ checkbox 712. As will be described below, alternative names may be added at the time that the user prepares a title page for the supporting attachment.

In preferred embodiments, the reference register 700 includes further interactive fields or elements, such as buttons, checkboxes, or drop down menus, for the user to access some functions of the system. These will typically be functions that have the potential to affect the information included in the reference register. For example, in FIG. 7, the reference register 700 includes an element 714 which allows the user to select whether the finalised document will have pagination which is continuously numbered, or have pagination which restarts for each section (primary document and each supporting attachment being different sections). In this example, the element 714 is a drop down menu. The reference register 700 in this example also includes an element 716 which allows the user to choose whether the reference register will be automatically synchronised with the current state of the primary document. In the depicted example the interface element 716 is provided for the user to toggle between the two options. Alternatively, the role of the interface element 716 may be replaced by two separate elements, one for the selection of each option.

A check box 718 may be provided to turn on an automatic backup function. The selection of the auto-backup function will cause the system to create a back-up copy of the document, the reference objects associated with the document, and selected options, every time an instance of reference is added or deleted. There may also further be a button or check box 720 which the user activates or enables, to turn on the editing capability for a finalised document.

An optional attachment index key selector portion 722 enables the user to select between different types of attachment index keys to be used in the attachment marker. In the example, the index key selector portion 722 includes separate buttons for the “number” option for numeric keys, “alpha” option for alphabetical keys, and “none” for the option to not include index keys. If no index keys are used, the result is that the attachment markers with the same attachment name will now all be identical—this is suitable for manually adding text before and/or after the reference name in the document. For example, if the name of a supporting attachment bundle (i.e., collection of attachments) is used as the reference name, and references are made directly to particular pages in the bundle, then it is preferable for the same attachment markers to be used.

FIG. 7-2 depicts a different example of the reference register. The reference register 750 includes the same types of information as those included in the reference register 700 shown in FIG. 7-1, however the relative display locations of the types of information are changed. For instance, in reference register 750, the files names 704 of the referenced attachments appear in the column immediately adjacent the column where the attachment markers for the supporting attachments 702 are displayed. Also, in reference register 750, a separate entry is assigned for each instance of reference to the supporting attachment. E.g., see the two entries having the same attachment marker ‘JRC_EXHIBIT “1”’.

An electronic index (not shown) may further also provided by the system and displayed in the user interface of the program. This may be in the form of a menu or a separate interface window which will be shown on a side portion of the user's screen. In the electronic index, the user can click on the attachment already within the supporting attachments library at any time, to review and determine if a new supporting document is required to be inserted or a supporting attachment already within the user library is to be re-used.

The user interface may be configured to display two reference registers. They may be exact copies of the electronic and reflect the finalised document. The displays may be configured to enable the two reference registers to be navigated differently, e.g., scrolled vertically, or scrolled horizontally. The user may be enabled to use a pointing device such as a mouse, to scroll through the fields of each register to review, or to enlarge or shrink either or both registers.

### Updating of Reference Register

In some embodiments, the document preparation system is configured to update the reference object database every time an instance of reference to a supporting attachment is added to or removed from the primary document. This may involve recalculating the attachment marker keys for the attachment markers. The document preparation system may further re-synchronise the attachment markers included in the reference register so that the recalculated attachment markers are used. The process described above with reference to FIG. 6-2 is an example for recalculating the attachment marker keys, to update the attachment markers and the reference objects.

In some embodiments, the document preparation system may be configured to be separate the function of recalculating the attachment marker key and resynchronising the reference register. This feature is helpful in cases where there are a large number of supporting attachments referenced in the primary document, e.g., more than say 50. By separating these functions, the processing time for resynchronising the reference register will only be incurred when the user choses to manually synchronise the reference register, or when the document is finalised.

For instance, as earlier discussed in relation to FIG. 7-1 and FIG. 7-2, optionally, the interface displaying the reference register 700 is configured to allow the user to select between automatically synchronising the reference register every time a reference is inserted or deleted, and locking the reference register so that it will not be synchronised.

The option for auto-synchronisation and the option for locking the reference register, may additionally or alternatively be accessible elsewhere in the program application, e.g., in a top menu in the application interface.

In some embodiments, the insertion of a new attachment marker will trigger the interface to display a functional interface in which the user can select between the two options, when the number of reference exceeds the aforementioned threshold level which is pre-set.

It will be appreciated that not all implementations of the disclosed system are required to provide the user the ability to choose between automatic syncing or locking the reference register.

### Title Pages for Supporting Attachments

In some cases, separate title pages are needed for each supporting attachment. This may be due to the particular documentary compliance rules or other requirements which the document needs to meet. In existing solutions such as Microsoft Word or GoogleDocs, the user is permitted to generate the title pages for the supporting attachments individually. Any formatting or template which is needed to applied will need to be manually applied to these title pages. If there are changes to the title due to a change in the attachment marker name, the changes will need to be manually made to the title pages. Further, once a title page for a supporting attachment is generated, it may need to be manually merged with the supporting attachment either directly in Microsoft Word, GoogleDocs or using a program such as Adobe®. Hard copies of the title page supporting attachment may even need to be physically collated, and scanned if a soft copy is required.

The presently disclosed document preparation system is configured to automate the generation of the title page for a supporting attachment and the collation to combine the title page and the supporting attachment, irrespective of the file type of the supporting attachment.

The document preparation system is configured to, when a user chooses to finalise a document, cause the program application to display a title page interface. The title page interface may allow the user to select to generate a title page, or to not generate a title page, for each supporting attachment. The user's interaction with the title page interface to choose to generate a title page may trigger the system to further display a menu of title page templates from which the user may select. The user may then have the choice between selecting a template to use, or navigating from the data drive(s) of the local computing system to import another template to use, or downloading and save a new template into the document preparation system. The user may alternatively not choose any particular template for the title pages. During finalisation, the attachment marker name and attachment marker key (or the attachment marker) will be automatically populated into the title page. The attachment markers populated into the title page will optionally be provided with (e.g., being embedded with) navigation destination links. This allow the document to be automatically navigated (e.g., auto-scrolled), so that when the user clicks on any instance of the same attachment marker included in the primary document, the interface will navigate to the supporting attachment.

In embodiments where the document preparation system is configured to allow the user to edit the title page, e.g., by adding a logo or text, or by adding an alternative name for the supporting attachment, the alternative name will be displayed instead of or alongside the attachment marker. The title page editing function may be configured to modify the alternative name property associated with the attachment marker, on the confirmation of an alternative name for a supporting attachment being entered. In embodiments where the title page editing is enabled, the editing function may be accessible to the user prior to the system collating the title page to the supporting attachment.

### Title Pages and Reference Index for Supporting Attachment Bundle

The document preparation system may further be configured to generate a supporting attachment bundle title page, to delineate between the primary document and the bundle of one or more supporting attachments to be compiled with the primary document. For example, the document preparation system may be configured to allow the user to choose this function using an interface element provided within one or more of the interfaces provided by the system. The function may be accessible by selecting an item in a function menu.

The document preparation system may further be configured to include a reference index page. The reference index page, if chosen, may be inserted after the supporting attachment bundle title page. As an example, the reference index page will include the reference index 500 described above with reference to FIG. 5.

The reference index page is generated at the time that the user chooses to compile or finalise the document, if the function to include the reference index is selected. Subsequent commands to recompile the document will cause the system to re-generate the reference index page to reflect the current state of the reference register or reference index, at the time that the command to recompile the document is made.

### Pagination of Supporting Attachments in the Support Attachment Bundle

The document preparation system may be configured to provide pagination to the supporting attachments. The pagination may be alpha-numeric. The pagination used may be specific to each supporting attachment-for example, the supporting attachment “exhibit A” may be paginated page A-1 to A-5, etc, and supporting attachment “exhibit B” may be paginated as pages B-1 to B-2, etc. Alternatively the different supporting attachment each have the same system of pagination. For instance both “exhibit A” and “exhibit B” will both have a pagination system of “1, 2, 3, . . . ”

The document preparation system, via the use of the data objects such as the reference register or the reference objects, is able to determine the order in which the supporting attachments are referenced in the primary document, the number of pages included in each supporting attachment, and whether any title pages are used for the supporting attachments. Thus, on the basis of this information, the system can automatically assign the page number, in accordance with the pagination system associated with the document.

In some embodiments, performing the function of referencing a new supporting attachment in the primary document will cause the attachment to be appended the end to the primary document if no other supporting attachments have been appended. Or, the supporting attachment will be appended after one or more different, earlier referenced supporting attachments that have already been appended to the primary document. The automatic assignment of the page numbers may be done at the time of appending the supporting attachment.

This avoids the manual process with the prior art, where the page numbering and the order of referenced supporting attachments may need to be realigned with the current state of the primary document, and then cross-checked with the reference register or index, when new supporting attachments are inserted.

### Finalisation of the Document and Supporting Attachments

In the prior art system, before finalising the report or document, all of the details of any markers or names used to refer to the supporting attachments, and the details of the actual supporting attachments, need to be checked to ensure they are synchronised and aligned with the text in the primary document.

In the disclosed document preparation system, this cross checking is not required, because of the properties built into the reference objects, and also because the attachment marker names are automatically linked to unique attachment marker keys which are updated during the document generation workflow. This enables the reference register, if included, to be synchronised at the same time that the attachment marker keys are updated, or when the document is compiled, as mentioned above.

Therefore, the compilation is completely automated, to collate the supporting attachment (and any title pages) with the primary document, and finalise the overall prepared document. In one example, the automated compilation involves the following:
Ordering of the supporting attachments utilising the attachment marker, which will automatically reflect the order in which these supporting attachments are referenced in the primary document.
Formatting of the primary document utilising the imported templates if requested by the user.
Associating the supporting attachments with the primary document, whereby the supporting documents they may be provided as hidden files which are displayed when triggered by user selection, or whereby the supporting documents are directly attached or appended to the primary document.
Generating the reference index. The index displays information regarding where each supporting attachment is referenced, and also may identify where the supporting attachment is located in the attachment bundle.
Adding pagination in accordance with the pagination system which is chosen by the user or pre-set.
If applicable, finalising title page information for the title pages of the supporting attachments, or the title page for the supporting attachment bundle, or both.

A copy of the finalised file object can be saved into a read-only format (e.g., PDF format), suitable for transmission to a third party with no editing rights. Should the third party decide to re-save the read-only document into an editable version, any edits made to the editable version document will need to checked to ensure that the supporting documents have been referenced correctly.

The finalised file object can be saved in the existing format as set by the system, and be opened again for later editing if required, or to be sent to another user (e.g., a collaborator) with editing rights. The author or collaborator can then open (i.e., import) the file in the program interface of the instance of the document preparation system running on his or her computing device, unlock the document and make changes, and then re-finalise. The edited file, again, may be finalised and then saved or issued back to the author. The author or collaborator then is able to unlock the file again in the program interface, and undertake the editing process if desired.

When the file object is imported into the instance of the system running on a computing device and editing rights are granted, the system will recognise the reference objects and also the supporting attachment associated with or inserted in the file, and re-produce the editable primary document as per captured in the previously state of the finalised document.

### Pagination and Document Finalisation Process Examples

Examples of how the system automatically updates the page number are described with reference to FIG. 8-1 and FIG. 8-2.

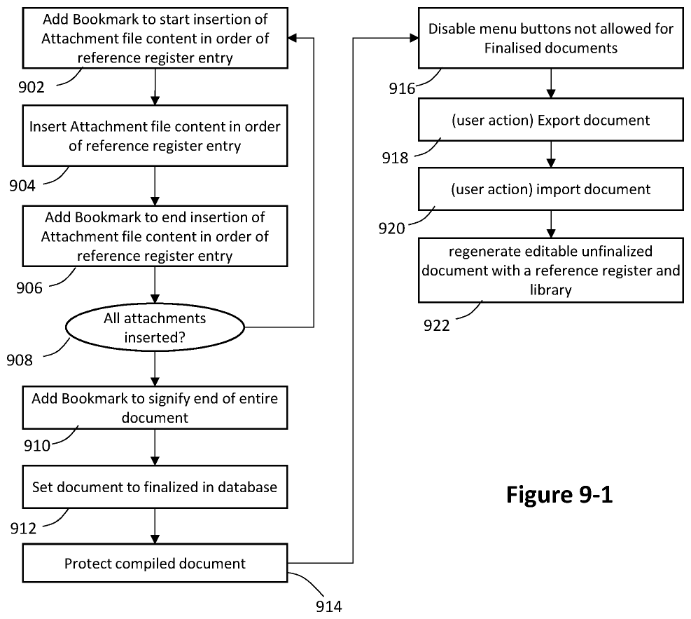

With reference to FIG. 8-1. At step 802, a reference is made by the user to a new supporting attachment. In this embodiment, this reference will only cause the reference register to be synchronised if a synchronisation condition is met. Examples of the condition include, if the total number of referenced supporting attachments are under a threshold number (e.g., 50), when the function to always synchronise the reference register is selected, or when the user triggers the synchronisation function at any time. Therefore, at step 804, the system checks whether any of the synchronisation conditions are met. If any of the synchronisation condition is met, then the system will synchronise the reference register at step 806.

At step 808, a selection is made to select the pagination system. This may be automatically triggered by the newly referenced supporting attachment being inserted, or may be manually selected by a user. This step may occur after the reference register synchronisation (step 806) if the synchronisation condition(s) was met, or without the reference register having been synchronised with the new state of the references.

Depending on what pagination system has been set or selected for the current document, different pagination will be applied. In this example, at step 810, the program is set to select a continuous pagination system, with continuous page numbering from the start of the primary document to the end of the appended supporting attachments. At alternative step 812, the pagination system is set to start at the beginning of the primary document, and restart at the beginning of the supporting attachment bundle. Still alternatively, the pagination may be set to start the beginning of the primary document and then restart at the beginning of each supporting attachment.

The pagination can then be finalised in accordance with the selected pagination system at step 842. Step 842 for finalising the page number calculation is preferably performed when the user chooses to finalise the document.

The process shown in FIG. 8-1 does not prompt for the use of any template. FIG. 8-2 schematically depicts an alternative process which starts from the selection of the pagination system (steps 810 or 812), where template selection is enabled. This process also assumes that various templates which may be used include a contents page template, an attachment bundle introductory page template, and an attachment title page template.

As shown in FIG. 8-2, pagination selection is made at step 810 or step 812. At step 814, the system enables the user to select the option to choose a template for a contents page of the document or not. At step 816, the user selects the option, and chooses and/or previews a contents page template. At step 818, the system enables the user to select the option to choose an attachment bundle introductory page template. At step 820, the user selects the option, and chooses and/or previews an attachment bundle introductory page template. At step 822, the system enables the user to select the option to choose an attachment title page template. At step 824, the user selects the option, and chooses and/or previews an attachment title page template.

In preferred embodiments, the following steps occur only when the user finalises the document.

Once the selections of the templates, or decisions to not select any templates, are confirmed, at step 826 the system inserts a book mark at the end of the primary document. At step 828, the system checks whether a contents page template is selected. In this example, the selection means that the contents table (e.g., reference index) will be shown, which may be on a separate page. At step 830, the system adds a book mark to the start of a contents page, inserts the contents page per the template, and adds a book mark to mark to the end of the contents pages. At step 832, the contents table is added. This will be added to the contents page template if a template is used, or directly added to the end of the primary document.

At step 834, the system checks whether an attachment bundle introductory (i.e., title) page template has been selected. At step 836, the system adds a book mark to the start of an attachment bundle introductory page, inserts the attachment bundle introductory page per the template, and adds a book mark to mark to the end of the attachment bundle introductory page.

At step 838, the system checks whether an option to insert an attachment index page has been selected. This page may be inserted before or after the attachment bundle introductory page. At step 840, the system adds a book mark to the start of an attachment index page, inserts the attachment index page, and adds a book mark to mark to the end of the attachment index page. The system then imports the various templates and the index page (if included), and calculates the page numbers, at step 842. The system may return to step 802 at the start of FIG. 8-1, to repeat the process and re-finalise the page numbers as needed, to reflect any changes to the state of the referenced supporting attachments.

The pagination process, such as the process of FIG. 8-1 or the extended process combining FIG. 8-1 to FIG. 8-2, will be repeated when the finalisation function is performed after a change occurs to the work flow to insert or delete a supporting attachment.

Examples of how the system finalises a document prepared using the document preparation system are described with reference to FIG. 9-1 and FIG. 9-2.

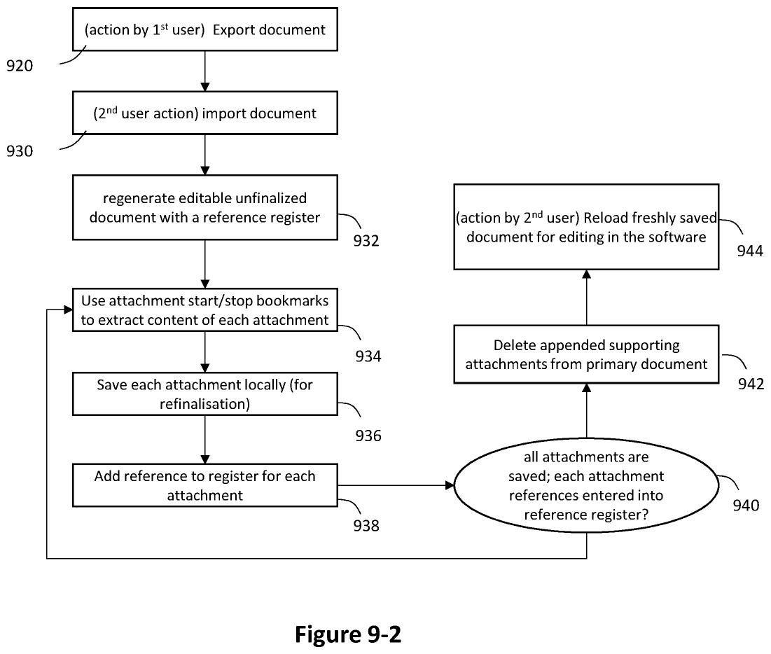

FIG. 9-1 depicts an example flow chart of the process which the document preparation system is configured to implement to finalise or compile the document. In this example process flow, the document preparation system will collate the supporting attachments with the primary document. Although not shown, the calculation of page numbers (step 842) may be first performed where the page numbering calculations are only triggered by the user's command to finalise or compile the document.

At step 902, the system adds an attachment start bookmark to the overall document to identify the insertion start location for a first referenced supporting attachment. At step 904, the first referenced supporting attachment is inserted, to append from the insertion start location. At step 906, the system adds an attachment end bookmark to identify the insertion end location for the first referenced supporting attachment. At step 908, the system checks to see if there are further referenced supporting attachments left. If one or more other supporting attachments are left, the system repeats steps 902 through 906. If all referenced supporting attachments have been inserted, the system moves to step 910. Thus in this example each supporting attachment collated with the primary document will be bookended by associated bookmarks.

At step 910, the system inserts a document end bookmark to identify the end for the entire collated document. At step 912, the system then marks the document as having been “finalised”, e.g., by changing the value of a “finalised” field to true. Following, at step 914, the system will lock the document so that it cannot be edited. The locking may be performed, by setting the value of a “locked” or “protected” field to true. In some embodiments, the user may be enabled to select to override the locking or protection of the compiled document, so that the primary document portion of a locked or compiled document can still be edited. However, in all embodiments, as long as the compiled document has been set to be protected or locked, no changes can be made to the attachment markers and the bundle of supporting attachments. Thus, responsive to the document being set to the protected or locked status at step 914, at step 916 the system disables the functions involved in editing the attachment markers or the supporting attachment bundle. If changes to these objects are required, the user or another having editing rights will need to unlock the compiled document. However, in a different embodiment, a user having editing rights may be enabled to edit the primary document while the compiled document is still in the locked condition. However any editing which involves the addition or removal of references will require unlocking.

Once the compiled document is locked, it can be exported, responsive to a user command (step 918). The exporting function will cause the compiled document file object to be saved into a data storage system accessible by the document preparation system.

A compiled document file object which has been saved can again be imported into the program responsive to a user command (step 920). At step 922, following importation of a compiled document file object, the system will regenerate an editable version of the document, along with a reference register. A supporting attachment library will also be regenerated from the supporting attachments included in the imported document. This ensures that the attachments included in the library are identical to those included at the time that the imported document was last compiled. Regeneration of the reference register may be performed by synchronising an initially empty reference register with the attachment markers included in, or the reference objects embedded in, the primary document portion. The user may then edit all portions of the uncompiled (unlocked) document as required. The user may re-lock the document again at any point, to compile and save the document, which can be then stored or sent to another user, or a third party. Regeneration of the supporting attachments library may be performed by extracting the supporting attachments, which may be bookended between supporting attachment bookmarks, and recompiling a local library.

FIG. 9-2 depicts an example process flow which can occur when a second user (e.g., editor or collaborator) imports a compiled document exported by a first user (e.g., author).

At step 920, the first user exports a compiled document file object. At step 930, the second user imports the compiled document file object. At step 932, the instance of the document preparation system on the second user's computing system will regenerate an unlocked and editable version of the imported file. A reference register may also be regenerated in the manner discussed above. The second user's instance of the document preparation system will further perform the following steps.

In this example, all of the supporting attachments collated with the primary documents are bookended by insertion start and end bookmarks. Thus, at step 934, the system will locate the attachment insertion start and end bookmarks, and extract the supporting attachments from the collated documents. At step 936, the extracted supporting attachments are saved into a local library created from the imported file object. A document path leading to a library sub-folder location for the document will be generated and assigned for each of the extracted and saved supporting attachments. The paths will provide the “file location” values in the reference object property values for the regenerated document. At step 938, a reference register entry for the locally saved supporting attachment will be added to the reference register.

At step 940, the system checks whether all of the supporting attachments have been extracted and saved, and corresponding reference register entries made. For instance, this may be done by the program ensuring that it has reached the document end bookmark which confirms the end of the entire collated document has been reached. If there are further attachments that still need to be extracted, steps 934 to 938 are repeated. Otherwise, at step 942, the system will “un-collate” the supporting attachments from the primary document. The “un-collating” may be done by deleting the supporting attachments appended to the end of the primary document. The system may identify the “attachment bundle start” bookmark and deleting everything after the bookmark. The document that remains after the deletion is then identified as the primary document.

At step 944, the second user can now edit the primary document as required, or permitted, or both.

Variations and modifications may be made to the parts previously described without departing from the spirit or ambit of the disclosure.

For example, in the above described embodiments, the supporting attachments being referred to within the primary document may be appended to the end of the primary document. However, in these or other embodiments, each supporting attachment may instead or additionally be enabled to be directly inserted in the primary document at a location which follows or which is defined by the associated attachment marker. For instance, it can be inserted into the primary document at a line which is beneath the attachment marker or the paragraph in which the attachment marker is used.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-32. (canceled)

33. A computer-implemented document preparation method, for preparation of a document object comprising a primary document, and one or more supporting attachments referenced within the primary document, the method comprising:
providing a primary document interface in which a primary document can be composed or edited by a user;
assigning, to the or each supporting attachment referenced in the primary document, a unique attachment marker comprising an attachment marker name and an automatically determined attachment marker key, wherein the attachment marker key or keys assigned to the one or more supporting attachments is or are updatable in accordance with any changes to references to the one or more supporting attachments made in the primary document, so that for each supporting attachment, its unique attachment marker comprises an updated attachment marker key which reflects a current order in which the supporting attachment is referenced in the primary document relative to any other supporting attachment or supporting attachments having assigned thereto the same attachment marker name;
generating a finalised primary document having embedded therein with one or more attachment markers, each of which is used to uniquely identify its associated supporting attachment in the primary document; and
providing a document object which comprises the finalised primary document.

34. The method of claim 33, further comprising:
compiling a collation of the one or more referenced supporting attachments, in which the referenced supporting attachments are arranged in order of their referencing in the primary document; and
wherein providing the document object comprises compiling the collation with the primary document.

35. The method of claim 33, comprising:
providing a reference insertion function, for adding a reference to a supporting attachment in the primary document; and
providing a reference removal function, for removing a reference to a supporting attachment in the primary document.

36. The method of claim 35, wherein a user-triggered invocation of the reference insertion function causes a reference selection interface to be displayed.

37. The method of claim 36, wherein the reference selection interface comprises a first interface element for selection of a supporting attachment to be referenced, from a listing of one or more supporting attachments included in a local library.

38. The method of claim 37, the reference insertion function being configured for:
upon user confirmation of a selection from said listing of supporting attachments from the local library, checking whether the selected supporting attachment has been previously referenced in the primary document, wherein
in the positive, designating the selected supporting attachment as the supporting attachment to be referenced by the invocation of the reference insertion function; and
in the negative, designating the selected supporting attachment as the supporting attachment to be referenced by the invocation of the referenced insertion function, and designating the selected supporting attachment for inclusion with the primary document.

39. The method of claim 35, comprising, upon user activation of the new reference selection interface element:
triggering a display of a file selection window for navigation through a data storage system separate from the local library,
enabling a selection of a file stored in the data storage system as a supporting item of information,
making a copy of the selected supporting item of information,
saving the copy as a new supporting attachment and including the new supporting attachment in the local library; and
designating the new supporting attachment as the supporting attachment to be referenced by the invocation of the reference insertion function, and designating the new supporting attachment for finalisation with the primary document.

40. The method of claim 35, further comprising generating an attachment marker to be assigned to the referenced supporting attachment and inserting the attachment marker into the primary document, the attachment marker comprising an attachment marker name, and an attachment marker key which is automatically assigned on the basis of the attachment marker name, said attachment marker key being one of a set of sequentially arranged values.

41. The method of claim 40, wherein the automatic assigning of the attachment marker key comprises:
if the attachment marker name is a new attachment marker name, assigning a first value of the set of sequentially arranged values as the attachment key;
if the attachment marker name is a used attachment marker name, identifying a last used attachment marker in the primary document which includes the used attachment marker name, determining the attachment marker key of the identified last attachment marker, assigning a next available value from the set of sequentially arranged values which immediate follows the attachment marker key of the identified attachment marker;
assigning the generated attachment marker to the supporting attachment; and
inserting the generated attachment marker in the primary document.

42. The method of claim 33, comprising generating a database containing one or more reference objects, each associated with an instance of a reference made in the primary document, each reference object including a plurality of fields of object properties.

43. The method of claim 42, wherein the properties comprise:
a unique identifier;
an attachment marker name property, whose property value is the attachment marker name of the corresponding attachment marker,
the attachment marker index property, whose property value is the attachment marker key of the corresponding attachment marker.

44. The method of claim 43, wherein the properties further comprise a reference location property, whose property value designates a location in the primary document where the corresponding attachment marker is inserted.

45. The method of claim 42, comprising automatically updating the attachment markers currently assigned to the referenced supporting attachments, responsive to a user-triggered invocation of the reference insertion or deletion function, wherein updating the attachment markers comprises updating the database of reference objects to reflect a state of the primary document after invocation of the reference insertion or deletion function.

46. The method of claim 45, wherein updating the database of reference objects comprises:
generating a temporary data structure, the temporary data structure comprising a list of empty reference objects, one for each instance of reference which is included in the primary document;
copying into the temporary data structure, property values for the reference objects, from the database to be updated;
deleting all reference objects from the database of reference objects;
resetting property values of reference objects included in the temporary data structure, on the basis of the current state of references made in the primary document;
copying reference objects included in the temporary database back to the database of reference objects;
updating an attachment marker place holder property value for each reference object in the database of reference objects.

47. The method of claim 33, further comprising generating a reference register, and for each supporting attachment designated for collation with the primary document portion, adding a reference register entry, wherein each reference register entry comprises the attachment marker assigned in respect of the corresponding supporting attachment.

48. The method of claim 33, wherein compiling the collation of the attachment documents comprises generating an attachment bundle, the attachment bundle including one or more sets of bookmarks, each set of bookmarks comprising an attachment start bookmark and attachment end bookmark, for insertion of one referenced supporting attachment therebetween, the sets of bookmarks being arranged such that supporting attachments are inserted in accordance with an order in which they are referenced in the primary document

49. The method of claim 33, comprising providing a primary document template function, for importing of a primary document content template, wherein an invocation of the primary document template function populates the primary document interface with a selected template.

50. The method of claim 33, further comprising importing an externally generated document object, which is generated by another computing system, the externally generated document object comprising a primary document and a collation of supporting documents referenced in the primary document; and
on the other computing system:
importing the document object;
extracting supporting documents from the collation and building a local library using the extracted supported documents;
deleting the collation of supporting documents from the from the externally generated document object; and
enabling editing of the primary document.

51. A document generation system, comprising a processing means, said processing means having access to a memory location having stored therein machine instructions, which when executed cause the processing means to provide a document generation method, the method comprising:
providing a primary document interface in which a primary document can be composed or edited by a user;
assigning, to the or each supporting attachment referenced in the primary document, a unique attachment marker comprising an attachment marker name and an automatically determined attachment marker key, wherein the attachment marker key or keys assigned to the one or more supporting attachments is or are updatable in accordance with any changes to references to the one or more supporting attachments made in the primary document, so that for each supporting attachment, its unique attachment marker comprises an updated attachment marker key which reflects a current order in which the supporting attachment is referenced in the primary document relative to any other supporting attachment or supporting attachments having assigned thereto the same attachment marker name;
generating a finalised primary document having embedded therein with one or more attachment markers, each of which is used to uniquely identify its associated supporting attachment in the primary document; and
providing a document object which comprises the finalised primary document.

52. Computer readable medium comprising instructions which when executed cause a computer or a computing system to perform a document generation method, the method comprising:
providing a primary document interface in which a primary document can be composed or edited by a user;
assigning, to the or each supporting attachment referenced in the primary document, a unique attachment marker comprising an attachment marker name and an automatically determined attachment marker key, wherein the attachment marker key or keys assigned to the one or more supporting attachments is or are updatable in accordance with any changes to references to the one or more supporting attachments made in the primary document, so that for each supporting attachment, its unique attachment marker comprises an updated attachment marker key which reflects a current order in which the supporting attachment is referenced in the primary document relative to any other supporting attachment or supporting attachments having assigned thereto the same attachment marker name;
generating a finalised primary document having embedded therein with one or more attachment markers, each of which is used to uniquely identify its associated supporting attachment in the primary document; and
providing a document object which comprises the finalised primary document.
